(19) United States
(12) Patent Application Publication
(10) Pub. No.: US 2026/0066624 A1
(43) Pub. Date: Mar. 5, 2026

(54) LAPLESS MAIN CIRCUIT CONNECTION STRUCTURE AND UNIT ASSEMBLY

(71) Applicant: CHANGZHOU XINYUANXING ELECTRICAL APPLIANCES CO., LTD, Changzhou (CN)

(72) Inventors: Yaohuan MO, Changzhou (CN); Hui ZHAO, Changzhou (CN); Jianxin ZHANG, Changzhou (CN); Yuanxing MO, Changzhou (CN); Mingjun JI, Changzhou (CN); Liqi YANG, Changzhou (CN)

(21) Appl. No.: 19/385,915

(22) Filed: Nov. 11, 2025

Related U.S. Application Data
(63) Continuation-in-part of application No. PCT/CN2023/096495, filed on May 26, 2023.

(30) Foreign Application Priority Data
May 12, 2023 (CN) 202310542207.0

(51) Int. Cl. H02B 1/21; H02B 11/173

(52) U.S. Cl. CPC H02B 1/21; H02B 11/173

(57) ABSTRACT

The present invention relates to a lapless main circuit connection structure and a unit assembly. The lapless main circuit connection structure includes circuit breaker connector bars and main circuit connectors, and the circuit breaker connector bars are directly inserted into the main circuit connectors and are connected to plug front sockets of conductive plugs in a plug-in manner. The unit assembly includes a unit and a unit chamber, a circuit breaker is installed in the unit, and the circuit breaker is connected to a main circuit through the lapless main circuit connection structure. The beneficial effects are that: the main circuit connectors in the present solution are double-socket structures and are not provided with terminal bars, the number of lap points is reduced, and the connection distance H and the copper consumption for copper bars connected to the main circuit are reduced. In a unit adopting the lapless main circuit connection structure, the unit depth L can be further reduced, thus achieving the miniaturization of the unit. A switchgear is miniaturized, and the application of the device reduces the infrastructure cost. For application design for the current levels of various types of circuit breakers, a permanent design finalization structure can be formed by design only once, and the standardization degree of the main circuit connection structure is greatly improved.

### RELATED APPLICATIONS

This application is a continuation-in-part (CIP) application claiming benefit of PCT/CN2023/096495 filed on May 26, 2023, which claims priority to Chinese Patent Application No. 202310542207.0 filed on May 12, 2023, the disclosures of which are incorporated herein in their entirety by reference.

### FIELD OF THE INVENTION

The present invention relates to the technical field of low-voltage switchgears, in particular to a lapless main circuit connection structure and a unit assembly

### DESCRIPTION OF THE PRIOR ART

Low-voltage switchgears are classified into drawer type and plug-in type units. Circuit breakers used therein all have a fixed main circuit connection structure. The main circuit connection structure of a drawer type unit assembly is as follows: main circuit movable connectors are used to connect to circuit breakers, the main circuit movable connectors are connected to a vertical busbar through conductive plugs in a plug-in manner, and main circuit fixed connectors for outgoing lines are connected in a plug-in manner. The main circuit connection structure of a plug-in type unit assembly is as follows: conductive connection pieces are fixed behind fixed circuit breakers, a base is arranged, the base is connected to the circuit breakers through sockets in a plug-in manner, and an incoming end of the base is fixedly connected to a vertical busbar through a circuit breaker connector bar.

Taking 630 A current rating as an example, for these two main circuit connection structures, the occupied depth of a drawer type unit is 450 mm, and the occupied depth of a plug-in type unit is 450 mm. Furthermore, the unit depth L and width of the low-voltage switchgear are defined to meet the technical requirements of 630 A main circuit connection. The main circuit connection structure of a currently commonly seen 630 A drawer type unit assembly is as shown in FIG. 1. The spacing between a fixing position of a circuit breaker and a unit rear end plate where a main circuit movable connector is installed, namely connection distance H, is 180 mm, and the unit depth Lis 450 mm. The main circuit connection structure of a currently commonly seen 630 A plug-in type unit assembly is as shown in FIG. 2. The connection occupied space H between a rear surface of a base and a unit chamber rear plate must reach 150 mm, and the unit depth L is 450 mm. The main circuit connection structure of the drawer type unit in FIG. 1 requires secondary transition, namely busbar flipping, to connect to the circuit breaker. The connection structure type is complex, the installation is labor-intensive, and the copper consumption for the 630 A circuit breaker connector bar, i.e., the copper bar, reaches 5.5 kg. The copper consumption for the circuit breaker connector bar of the main circuit connection structure of the plug-in type unit in FIG. 2 is 3 to 3.6 kg. However, the connection between the circuit breaker connector bar on an incoming side of the base and the vertical busbar is a fixed connection. Installation must be performed on a cabinet body, resulting in high work intensity and laboriousness. User feedback indicates that the plug-in type main circuit connection structure does not meet the requirements for maintenance without power interruption and rapid maintenance.

Drawer type units and plug-in type units have requirements for instrument transformer arrangement. Furthermore, the models of circuit breakers applied are too numerous, the phase-to-phase center distance D of different circuit breaker models varies, the specifications of circuit breaker connector bars also differ, and the external dimensions of the instrument transformers applied vary in size.

The main circuit connection structure of the drawer type unit assembly shown in FIG. 1 has the problems of large connection distance H and large copper consumption. The main circuit connection structure of the plug-in type unit assembly shown in FIG. 2 has the problems of numerous connection points, complex connection process, and large connection distance H.

Currently, relevant power departments in the industry advocate for the miniaturization of new power equipment, energy saving and emission reduction, cost reduction, and improvement of technical quality and performance. The cabinet depth of low-voltage switchgear is 800 mm, and the cabinet width W is 500 mm.

The applicant developed a main circuit connection structure in 2019, specifically disclosed in the invention patent document CN201911305639.X. This main circuit connection structure solves the technical problems of reducing connection points and shortening the connection distance H by arranging the phase-to-phase centers of the main circuit connectors corresponding to the phase-to-phase centers of the corresponding phases of the circuit breakers. Compared with the main circuit connection structure of the drawer type unit in FIG. 1, the connection distance H can be reduced by 45 mm. Through the transformation of achievements, a drawer type unit with a cabinet width W of 500 mm and a unit depth L of 400 mm as shown in FIG. 3 was achieved, and simultaneously, a movable plug-in type unit with a cabinet width W of 600 mm and a unit depth L of 350 mm was achieved.

However, the main circuit movable connector has a terminal bar, used for connecting to the circuit breaker connector bar. There is still one lap point between the circuit breaker connector bar and the terminal bar of the main circuit movable connector. The presence of the lap point occupies the connection distance length.

### SUMMARY OF THE INVENTION

The technical problem to be solved by the present invention is: how to further reduce the connection distance H and the copper consumption for copper bars for main circuit connection, and achieve the technical objective of further reducing the unit depth; to further solve: reducing the connection distance and reducing the unit depth, realizing the miniaturization of 630 A unit equipment, namely defining higher feasibility for switchgear miniaturization, and realizing the application technology for plug-in type units with a cabinet width of 500 mm.

The technical solution adopted by the present invention to solve the technical problem thereof is as follows: a lapless main circuit connection structure, comprising circuit breaker connector bars and main circuit connectors, the circuit breaker connector bars being used for conductive connection between circuit breaker and the main circuit connectors, the main circuit connectors being connected through conductive plugs in a plug-in manner, wherein the main circuit connectors connected to the circuit breakers through the circuit breaker connector bars are dual-socket main circuit connectors, and the circuit breaker connector bars are directly inserted into the dual-socket main circuit connectors and are connected to plug front sockets of the conductive plugs in a plug-in manner.

Preferably, the dual-socket main circuit connectors comprise plug insulating housings and conductive plugs positioned through the plug insulating housings, the conductive plugs are provided with plug front sockets and plug rear sockets, the plug insulating housings are provided with circuit breaker connector bar sockets, the circuit breaker connector bars are directly inserted into the main circuit connectors through the circuit breaker connector bar sockets and are connected to the plug front sockets of the conductive plugs in a plug-in manner, the dual-socket main circuit connectors serve as movable connectors and are fixed to a unit rear end plate through the plug insulating housings, and the circuit breaker connector bars and the plug insulating housings are fixed through fasteners.

Alternatively, the dual-socket main circuit connectors comprise plug insulating housings and conductive plugs positioned through the plug insulating housings, the conductive plugs are provided with plug front sockets and plug rear sockets, the plug insulating housings are provided with housing front sockets, the circuit breaker connector bars are directly inserted into the main circuit connectors through the housing front sockets and are connected to the plug front sockets of the conductive plugs in a plug-in manner, the dual-socket main circuit connectors serve as stationary connectors and are fixed to a unit chamber rear plate through the plug insulating housings, rear ends of the circuit breaker connector bars serve as movable connectors and are fixed to a unit rear end plate through movable connector insulating housings, the movable connector insulating housings are provided with circuit breaker connector bar sockets, the rear ends of the circuit breaker connector bars pass through the circuit breaker connector bar sockets, and the rear ends of the circuit breaker connector bars and the movable connector insulating housings are fixed through fastener.

Further preferably, the circuit breaker connector bar sockets have a certain length for guiding the insertion of the circuit breaker connector bars into the conductive plugs for connection.

Further preferably, the fasteners are detachable fasteners, the detachable fasteners are specifically bolt fasteners, side surfaces of the circuit breaker connector bars and the circuit breaker connector bar sockets are provided with fixing through holes, and the bolt fasteners fix the circuit breaker connector bars by passing through the fixing through holes of the circuit breaker connector bars and the circuit breaker connector bar sockets.

Preferably, main circuit connectors of each phase on an incoming side and an outgoing side connected to the circuit breakers through the circuit breaker connector bars are arranged in layers from top to bottom, phase-to-phase centers CL are arranged corresponding to phase-to-phase centers CL of corresponding phases of the circuit breakers, the main circuit connectors of each phase on the incoming side and the outgoing side connected to the circuit breakers through the circuit breaker connector bars are connected to the corresponding phases of the circuit breakers in a one-to-one correspondence through the circuit breaker connector bars arranged in layers from top to bottom.

A unit assembly, specifically a unit assembly of a low-voltage switchgear, comprising a unit and a unit chamber, wherein a circuit breaker is installed in the unit, and the circuit breaker is connected to a main circuit through the lapless main circuit connection structure described above.

Preferably, a B-phase instrument transformer sleeved over a B-phase circuit breaker connector bar on an outgoing side is installed through an instrument transformer bracket installed on a unit rear end plate, and the B-phase instrument transformer is arranged close to a B-phase main circuit connector.

The beneficial effects of the present invention are that: the main circuit connectors in the present solution are double-socket structures and are not provided with terminal bars, the number of lap points is reduced, the connection distance H and the copper consumption for copper bars connected to the main circuit are reduced, and the cost is reduced as the main circuit connectors no longer require copper connector bars.

In a 630 A unit adopting the lapless main circuit connection structure according to the present invention, the unit depth L can be further reduced, thus achieving the miniaturization of the unit and reducing the infrastructure cost.

The lapless main circuit connection structure according to the present solution is a connection structure with an extremely high degree of standardization. It is designed for application across various model types and current ratings of circuit breakers. Combined with the phase-to-phase centers CL of the main circuit connectors being arranged corresponding to the phase-to-phase centers CL of the corresponding phases of the circuit breakers, it becomes a permanent, finalized design structure after being designed only once.

The lapless main circuit connection structure according to the present solution and the installation process of the circuit breakers are both performed on a working platform, thus saving the installation labor.

### BRIEF DESCRIPTION OF THE DRAWINGS

The present invention will be further described below in conjunction with the drawings and embodiments.

FIG. 1 is a structural schematic diagram of an existing 630 A drawer type unit assembly with main circuit connection achieved through busbar flipping;

FIG. 2 is a structural schematic diagram of an existing 630 A plug-in type unit assembly;

FIG. 3 is a structural schematic diagram of an existing 630 A drawer type unit assembly with main circuit connection achieved through alignment of phase-to-phase centers CL;

FIG. 4 is a structural schematic diagram of a 125 A conductive plug according to the present invention;

FIG. 5 is a structural schematic diagram of a 250 A conductive plug according to the present invention;

FIG. 6 is a structural schematic diagram of a 375 A conductive plug according to the present invention;

FIG. 7 is a structural schematic diagram of a dual-socket main circuit connector of a connector structural form I according to the present invention;

FIG. 8 is a structural schematic diagram of a dual-socket main circuit connector of a connector structural form II according to the present invention;

FIG. 9 is a structural schematic diagram of a dual-socket main circuit connector of a connector structural form III according to the present invention;

FIG. 10 is a structural schematic diagram of a connector structural form I with a plug rear housing removed from a front perspective according to the present invention;

FIG. 11 is a structural schematic diagram of a connector structural form I with a plug rear housing removed from a rear perspective according to the present invention;

FIG. 12 is a structural schematic diagram of a connector structural form II with a plug rear housing removed from a front perspective according to the present invention;

FIG. 13 is a structural schematic diagram of a connector structural form III with a plug from housing removed from a front perspective according to the present invention;

FIG. 14 is a structural schematic diagram of lapless connection of a circuit breaker connector bar to a connector structural form I according to the present invention;

FIG. 15 is a structural schematic diagram of fixation of a circuit breaker connector bar to a movable connector insulating housing according to the present invention;

FIG. 16 is a structural schematic diagram of plug-in connection of a connector structural form I to a vertical busbar according to the present invention;

FIG. 17 is a structural schematic diagram of plug-in connection of a connector structural form III to a vertical busbar according to the present invention;

FIG. 18 is a structural schematic diagram of plug-in connection of a connector structural form I or II to an outgoing stationary socket according to the present invention;

FIG. 19 is a structural schematic diagram of a 125 A dual-socket main circuit connector adopting a first structural principle according to the present invention;

FIG. 20 is a structural schematic diagram of a 250 A dual-socket main circuit connector adopting a first structural principle according to the present invention;

FIG. 21 is a structural schematic diagram of a 400 A dual-socket main circuit connector adopting a first structural principle according to the present invention;

FIG. 22 is a structural schematic diagram of a 125 A dual-socket main circuit connector adopting a second structural principle according to the present invention;

FIG. 23 is a structural schematic diagram of a 250 A dual-socket main circuit connector adopting a second structural principle according to the present invention;

FIG. 24 is a structural schematic diagram of a 400 A dual-socket main circuit connector of a second structural principle according to the present invention;

FIG. 25 is a structural schematic diagram of a lapless main circuit connection structure adopting a first structural principle according to the present invention;

FIG. 26 is a structural schematic diagram of a lapless main circuit connection structure adopting a second structural principle according to the present invention;

FIG. 27 is a structural schematic diagram of FIG. 25 from a rear perspective;

FIG. 28 is a structural schematic diagram of FIG. 26 from a rear perspective;

FIG. 29 is an assembly schematic diagram of a lapless main circuit connection structure adopting a first structural principle and a unit rear end plate according to the present invention;

FIG. 30 is an assembly schematic diagram of a lapless main circuit connection structure adopting a second structural principle and a unit rear end plate according to the present invention;

FIG. 31 is a structural schematic diagram of FIG. 29 from a from perspective;

FIG. 32 is a structural schematic diagram of FIG. 30 from a from perspective;

FIG. 33 is a general assembly schematic diagram of a 630 A drawer type unit assembly with a cabinet width W of 600 mm and a unit depth L of 300 mm of a lapless main circuit connection structure adopting a first structural principle according to the present invention;

FIG. 34 is a general assembly schematic diagram of a 630 A drawer type unit assembly with a cabinet width W of 600 mm and a unit depth L of 300 mm of a lapless main circuit connection structure adopting a second structural principle according to the present invention;

FIG. 35 is a general assembly schematic diagram of a 630 A drawer type unit assembly with a cabinet width W of 500 mm and a unit depth L of 300 mm of a lapless main circuit connection structure adopting a second structural principle according to the present invention;

FIG. 36 is a general assembly schematic diagram of a 630 A movable plug-in type unit assembly with a cabinet width W of 600 mm and a unit depth L of 300 mm of a lapless main circuit connection structure adopting a first structural principle according to the present invention;

FIG. 37 is a general assembly schematic diagram of 125 A and 250 A drawer type unit assemblies with a cabinet width W of 600 mm for a control loop of a lapless main circuit connection structure adopting a first structural principle according to the present invention;

FIG. 38 is a general assembly schematic diagram of FIG. 37 from a rear perspective;

FIG. 39 is a general assembly schematic diagram of 400 A and 650 A drawer type unit assemblies with a cabinet width W of 600 mm for a control loop of a lapless main circuit connection structure adopting a first structural principle according to the present invention;

FIG. 40 is a general assembly schematic diagram of FIG. 39 from a rear perspective;

FIG. 41 is a schematic diagram of phase-to-phase centers CL and phase-to-phase center distances D of circuit breakers according to the present invention; and

FIG. 42 is a schematic diagram of phase-to-phase centers CL and phase-to-phase center distances D of main circuit connectors according to the present invention.

### DESCRIPTION OF REFERENCE SIGNS

1. circuit breaker connector bar, 2. circuit breaker, 3. dual-socket main circuit connector, 4. conductive plug, 4-1. plug front socket, 4-2. plug rear socket, 5. plug insulating housing, 5-1. circuit breaker connector bar socket, 5-2. plug front housing, 5-3. plug rear housing, 5-4. housing front socket, 5-5. fixing through-hole, 6. unit rear end plate, 7. bolt fastener, 8. unit chamber rear plate, 9. movable connector insulating housing, 10. B-phase instrument transformer, 11. vertical busbar, 12. outgoing stationary socket, 13. conventional main circuit connector, 13-1. terminal bar, 14. instrument transformer bracket.

### DETAILED DESCRIPTION OF THE PREFERRED EMBODIMENTS

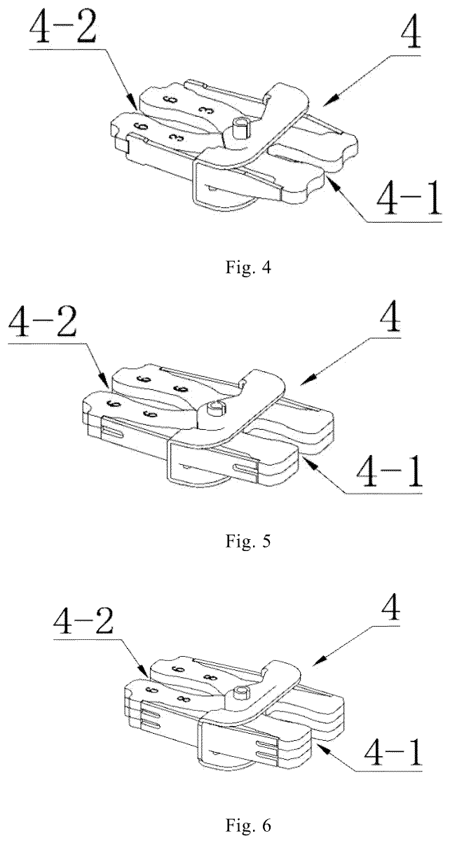

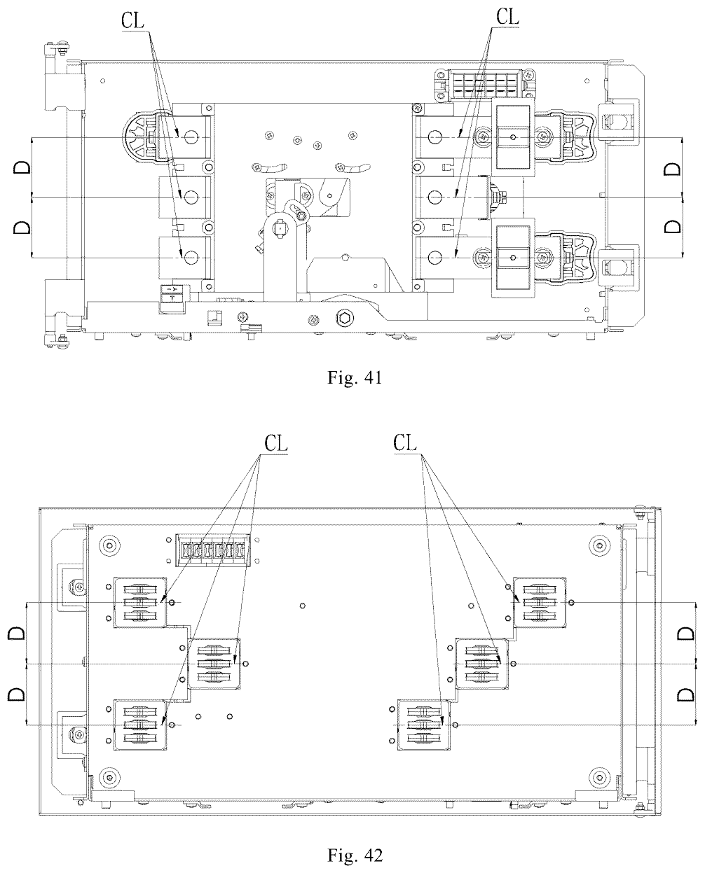

As shown in FIG. 4 to FIG. 42, a lapless main circuit connection structure comprises circuit breaker connector bars 1 and main circuit connectors, the circuit breaker connector bars 1 are used for conductive connection between circuit breakers 2 and the main circuit connectors, the main circuit connectors are connected through conductive plugs 4 in a plug-in manner, the main circuit connectors connected to the circuit breakers 2 through the circuit breaker connector bars 1 are dual-socket main circuit connectors 3, and the circuit breaker connector bars 1 are directly inserted into the dual-socket main circuit connectors 3 and are connected to plug front sockets 4-1 of the conductive plugs 4 in a plug-in manner.

Dual-socket main circuit connectors 3 of each phase on an incoming side and an outgoing side connected to the circuit breakers 2 through the circuit breaker connector bars 1 are arranged in layers from top to bottom, phase-to-phase centers CL are arranged corresponding to phase-to-phase centers CL of corresponding phases of the circuit breakers 2, the dual-socket main circuit connectors 3 of each phase on the incoming side and the outgoing side connected to the circuit breakers 2 through the circuit breaker connector bars 1 are connected to the corresponding phases of the circuit breakers 2 in a one-to-one correspondence through the circuit breaker connector bars 1 arranged in layers from top to bottom.

The dual-socket main circuit connectors (3) have two structural principles.

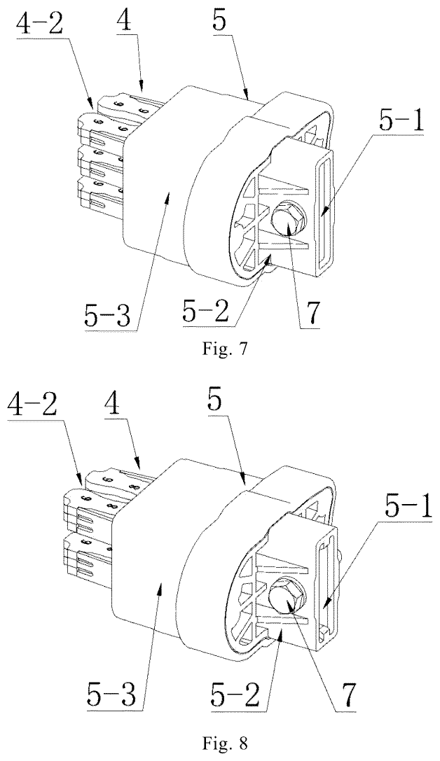

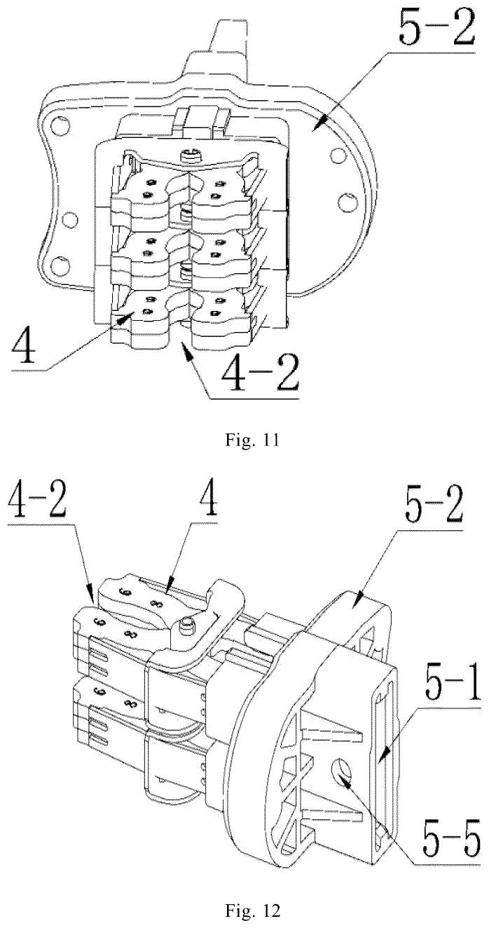

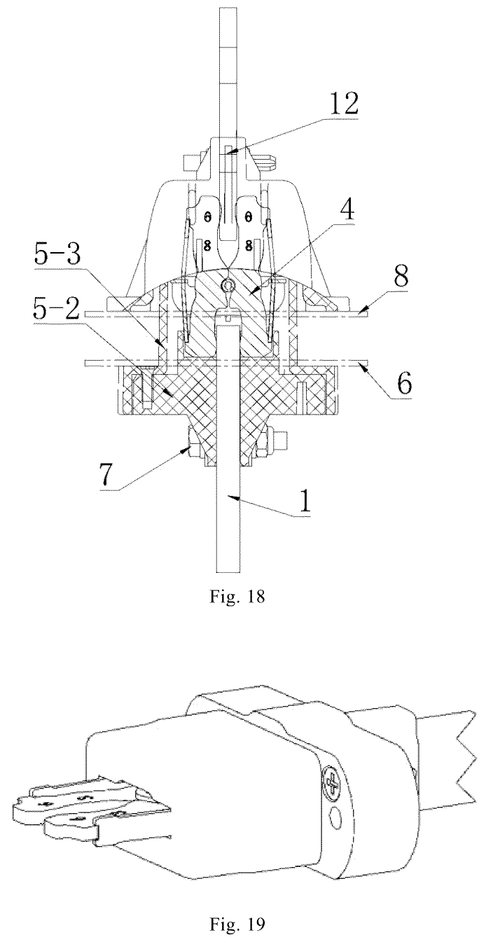

As shown in FIG. 7, FIG. 8, FIG. 10, FIG. 11, Fig. FIG. 12, 14, FIG. 16, and FIG. 18, in a first structural principle, the dual-socket main circuit connectors 3 adopting a first structural principle serve as movable connectors and are fixed to a unit rear end plate 6 through the plug insulating housings 5, and the circuit breaker connector bars 1 and the plug insulating housings 5 are fixed through fasteners.

The dual-socket main circuit connectors 3 comprise plug insulating housings 5 and conductive plugs 4 positioned through the plug insulating housings 5. The plug insulating housings 5 are provided with circuit breaker connector bar sockets 5-1, and the circuit breaker connector bars 1 are directly inserted into the dual-socket main circuit connectors 3 through the circuit breaker connector bar sockets (5-1) and are connected to the plug front sockets 4-1 of the conductive plugs 4 in a plug-in manner. The plug insulating housings 5 comprise plug front housings 5-2 and plug rear housings 5-3, the plug front housings 5-2 and the plug rear housings 5-3 are assembled together front and back to form the plug insulating housings 5, and the conductive plugs 4 are positioned in layers in the plug insulating housing 5.

The circuit breaker connector bar sockets 5-1 have a certain length for guiding the circuit breaker connector bars 1. The fasteners are detachable fasteners, the detachable fasteners are specifically bolt fasteners 7, side surfaces of the circuit breaker connector bars 1 and the circuit breaker connector bar sockets 5-1 are provided with fixing through holes 5-5, and the bolt fasteners 7 fix the circuit breaker connector bars 1 by passing through the fixing through holes 5-5 of the circuit breaker connector bars 1 and the circuit breaker connector bar sockets 5-1.

As shown in FIG. 4, FIG. 5, and FIG. 6, the conductive plug 4 is prior art. The conductive plug 4 is composed of a conductive sheet, a spring, a fixing bracket, and a tensioning and fixing shaft. The current rating of the conductive plug 4 is determined by the current-carrying capacity of the conductive sheet. The conductive plug 4 has a plug front socket 4-1 and a plug rear socket 4-2. The plug front socket 4-1 and the plug rear socket 4-2 of the conductive plug 4 are determined by the thickness of a vertical busbar 11. The pressure of the conductive plug 4 is determined by the spring. The tensioning and fixing shaft and the fixing bracket are assembled in a tensioning manner.

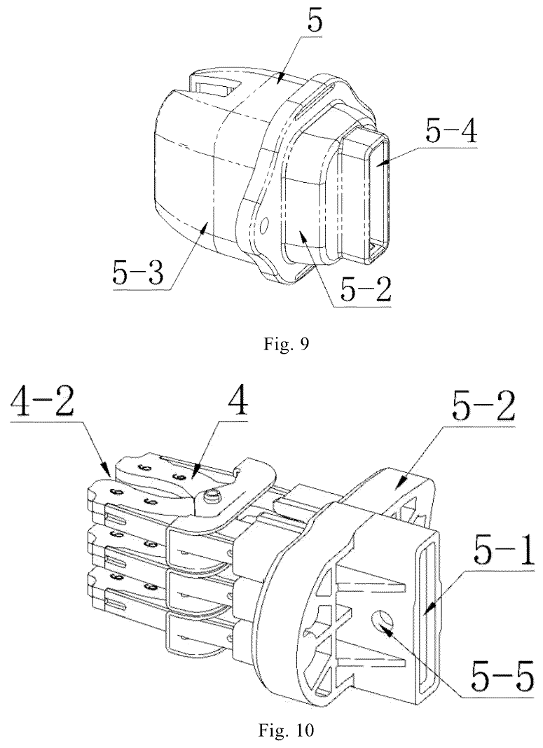

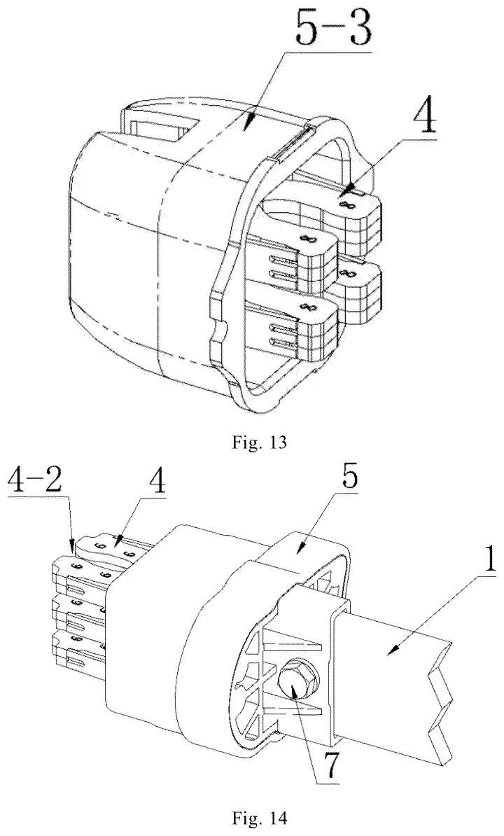

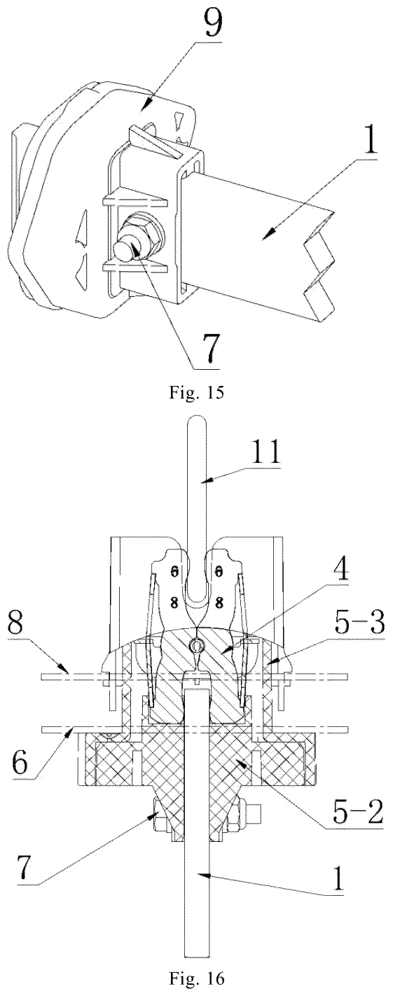

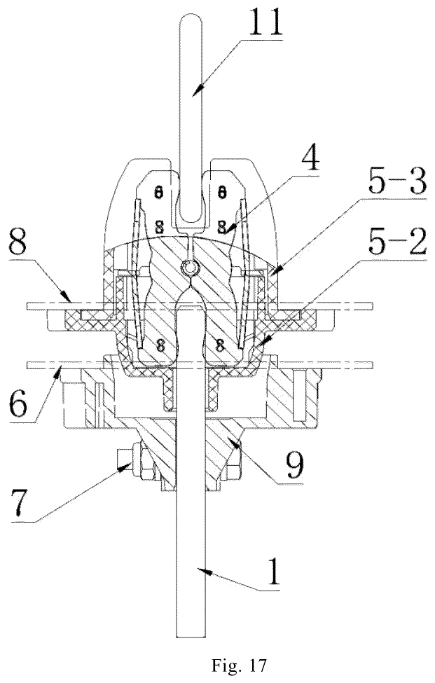

As shown in FIG. 9, FIG. 13, FIG. 15, and FIG. 17, the dual-socket main circuit connectors 3 adopting a second structural principle have the substantially same structure as the dual-socket main circuit connectors 3 adopting the first structural principle, and also comprise plug insulating housings 5 and conductive plugs 4 positioned through the plug insulating housings 5, the conductive plugs 4 are provided with plug front sockets 4-1 and plug rear sockets 4-2, the plug insulating housings 5 are provided with housing front sockets 5-4, and the circuit breaker connector bars 1 are directly inserted into the dual-socket main circuit connectors 3 through the housing front sockets 5-4 and are connected to the plug front sockets 4-1 of the conductive plugs 4 in a plug-in manner.

Compared with the first structural principle, the difference of the second structural principle lies in that the dual-socket main circuit connectors 3 serve as stationary connectors and are fixed to a unit chamber rear plate 8 through the plug insulating housings 5, rear ends of the circuit breaker connector bars 1 serve as movable connectors and are fixed to a unit rear end plate 6 through movable connector insulating housings 9, the movable connector insulating housings 9 are provided with circuit breaker connector bar sockets 5-1, the rear ends of the circuit breaker connector bars 1 pass through the circuit breaker connector bar sockets 5-1, and the rear ends of the circuit breaker connector bars 1 and the movable connector insulating housings 9 are fixed through fastener.

The housing front sockets 5-4 of the plug insulating housings 5 and the circuit breaker connector bar sockets 5-1 of the movable connector insulating housings 9 have a certain length for guiding the circuit breaker connector bars 1. Side surfaces of the circuit breaker connector bars 1 and the circuit breaker connector bar sockets 5-1 of the movable connector insulating housings 9 are provided with fixing through holes 5-5, and the bolt fasteners 7 fix the circuit breaker connector bars 1 by passing through the fixing through holes 5-5 of the circuit breaker connector bars 1 and the circuit breaker connector bar sockets 5-1 of the movable connector insulating housings 9.

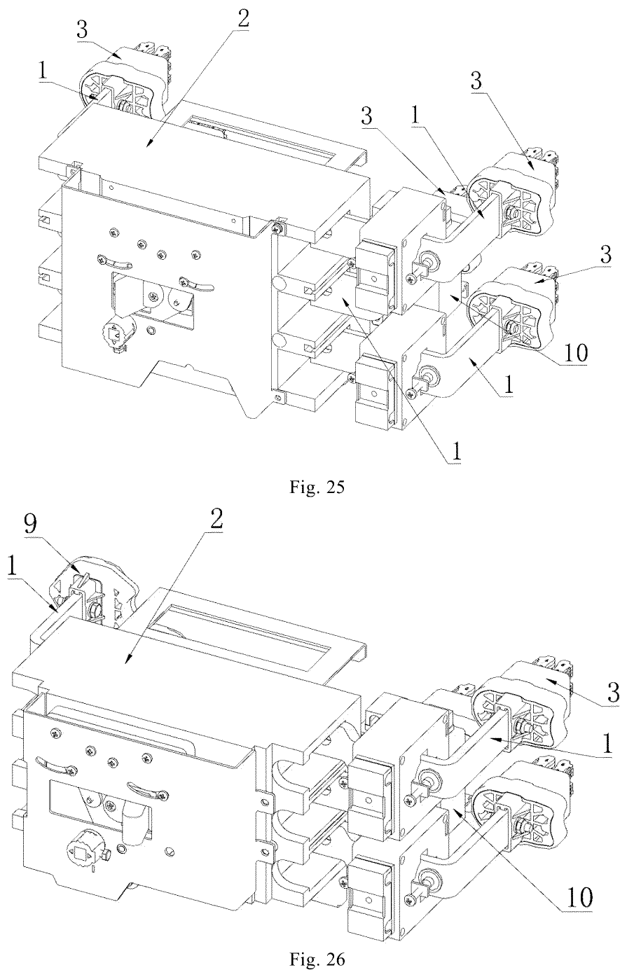

As shown in FIG. 25 to FIG. 40, a unit assembly, specifically a unit assembly of a low-voltage switchgear, comprises a unit and a unit chamber, a circuit breaker 2 is installed in the unit, and the circuit breaker is connected to a main circuit through the lapless main circuit connection structure described above.

A B-phase instrument transformer 10 on an outgoing side is installed through an instrument transformer bracket 14 mounted on the unit rear end plate 6, so that the B-phase instrument transformer 10 sleeved over a B-phase circuit breaker connector bar 1 is arranged close to a B-phase dual-socket main circuit connector 3 as soon as possible, thus reducing the influence of the B-phase instrument transformer 10 on the unit depth L. A-phase and C-phase instrument transformers only need to be installed using conventional methods. The structural principle of this instrument transformer arrangement is disclosed in the applicant's patent document CN202220361289.X.

Since the 630 A main circuit connection technical requirements determine the unit depth L and width of the low-voltage switchgear, once a 630 A lapless main circuit connection structure has been achieved, the same structural principle can likewise be achieved for 400 A, 250 A, and 125 A ratings. Therefore, the technical solution of the present invention will be further described in detail below in conjunction with the drawings, taking the 630 A lapless main circuit connection structure as an example.

The conductive plugs 4 have various structural forms and various different openings, which are determined by the application current, and the thickness and width of the vertical busbar 11.

When the current-carrying capacity of a single conductive sheet is 125 A, as shown in FIG. 4, a single conductive sheet is adopted to form a 125 A conductive plug 4; as shown in FIG. 5, two conductive sheets are adopted to form a 250 A conductive plug 4; as shown in FIG. 6, three conductive sheets are adopted to form a 375 A conductive plug 4.

The phase-to-phase center distances D of the 630 A circuit breakers 2 commonly used in the industry include 58 mm, 46 mm, 45 mm, 44 mm, and 43.5 mm. The size specifications of the 630 A circuit breaker connector bars 1 include 6*40, 8*30, and 8*35.

According to industry standards, the layer combination height of the conductive plug 4 of the 630 A main circuit connector must be 10 mm less than the height of the circuit breaker connector bar 1. The phase-to-phase electrical clearance for 630 A must meet the requirement of being not less than 12.5 to 16 mm.

When the phase-to-phase center distance of the 630 A circuit breaker 2 is 58 mm, the 6*40 specification circuit breaker connector bar 1 is used, resulting in a phase-to-phase electrical clearance of 18 mm, which complies with the phase-to-phase electrical clearance requirement. The layer combination height of three sets of 250 A conductive plugs 4 can adapt to the 6*40 specification circuit breaker connector bar 1.

When the phase-to-phase center distance of the 630 A circuit breakers 2 is 43.7 mm, 44 mm, 45 mm, or 46 mm, to meet the phase-to-phase electrical clearance requirement, it is necessary to use the 8*35 or 8*30 specification circuit breaker connector bars 1. The corresponding phase-to-phase electrical clearances are 13.5 mm, 14 mm, 15 mm, and 16 mm, respectively. Meanwhile, only the layer combination height of two sets of 375 A conductive plugs 4 can adapt to the 8*35 and 8*30 specification circuit breaker connector bars 1.

Therefore, the present invention provides three structural forms of the dual-socket main circuit connectors 3, targeting all models of the circuit breakers 2, and achieving comprehensive coverage and compatibility with all circuit breaker 2 models in the industry.

The three structural forms of the 630 A dual-socket main circuit connectors 3 are respectively a connector structural form I shown in FIG. 7, FIG. 10, and FIG. 11, a connector structural form II shown in FIG. 8 and FIG. 12, and a connector structural form III shown in FIG. 9 and FIG. 13.

The 630 A dual-socket main circuit connectors 3 of the connector structural form I and connector structural form II have the same structural principle, and adopt the first structural principle to achieve the lapless connection between the circuit breaker connector bars 1 and the dual-socket main circuit connectors 3, that is, the connector structural forms I and II serve as movable connectors fixed to the unit rear end plate 6 through the plug insulating housings 5, and the circuit breaker connector bars 1 and the plug insulating housings 5 are fixed through fasteners.

The difference between the connector structural forms I and II lies in that: the connector structural form I adopts three sets of 250 A conductive plugs 4, each formed by combining two conductive sheets, adapts to the 6*40 specification circuit breaker connector bars 1, and meets the lapless main circuit connection requirement for 630 A circuit breakers 2 with a phase-to-phase center distance greater than or equal to 55 mm, and the connector structural form I is universal for both the incoming side and the outgoing side;

the connector structural form II adopts two sets of 375 A conductive plugs 4, each formed by combining three conductive sheets, adapts to the 8*35 and 8*30 specification circuit breaker connector bars 1, and meets the lapless main circuit connection requirement for 630 A circuit breakers 2 with a phase-to-phase center distance greater than or equal to 43.7 mm, and the connector structural form II is only used for both the outgoing side.

The 630 A dual-socket main circuit connectors 3 of the connector structural form III adopt the second structural principle to achieve the lapless connection between the circuit breaker connector bars 1 and the dual-socket main circuit connectors 3, that is, the connector structural form III serves as stationary connectors fixed to the unit chamber rear plate 8 through the plug insulating housings 5, rear ends of the circuit breaker connector bars 1 serve as movable connectors fixed to the unit rear end plate 6 through the movable connector insulating housings 9, the movable connector insulating housings 9 are provided with circuit breaker connector bar sockets 5-1, the rear ends of the circuit breaker connector bars 1 pass through the circuit breaker connector bar sockets 5-1, and the rear ends of the circuit breaker connector bars 1 and the movable connector insulating housings 9 are fixed through fastener, as shown in FIG. 15 and FIG. 17.

The connector structural form III is used for the incoming side, where the conductive plugs 4 are directly connected to the vertical busbars 11 in a plug-in manner. The connector structural form III adopts two sets of 375 A conductive plugs 4, each formed by combining three conductive sheets, adapts to the 8*35 and 8*30 specification circuit breaker connector bars 1, and meets the lapless main circuit connection requirement for 630 A circuit breakers 2 with a phase-to-phase center distance greater than or equal to 43.7 mm.

The specific adaptation parameters for achieving the lapless main circuit connection structure according to the present invention by adopting the connector structural form I, the connector structural form II, and the connector structural form III are shown in the table below:

| | | | | | | | Specification |
|---|---|---|---|---|---|---|---|
| | | Phase-to- | Opening | | Opening | Specification | of copper |
| | | phase | of plug | | of plug | of circuit | bar of |
| Connector | | center | rear | Specification | front | breaker | outgoing |
| structural | Current | distance | socket | of vertical | socket | connector | stationary |
| form | (A) | D (mm) | 4-2 | busbar 11 | 4-1 | bar 1 | socket 12 |
| I | 630 | 58 | 4.6 | 6 | 4.6 | 6*40 | 6*40 |
| | | | 6.6 | 8 | | | |
| II | 630 | 46, 45, | 4.6 | 6 | 6.6 | 8*35 | 6*40 |
| | | 44, 43.7 | 6.6 | 8 | | 8*30 | |
| III | 630 | 46, 45, | 4.6 | 6 | 6.6 | 8*35 | 6*40 |
| | | 44, 43.7 | 6.6 | 8 | | 8*30 | |

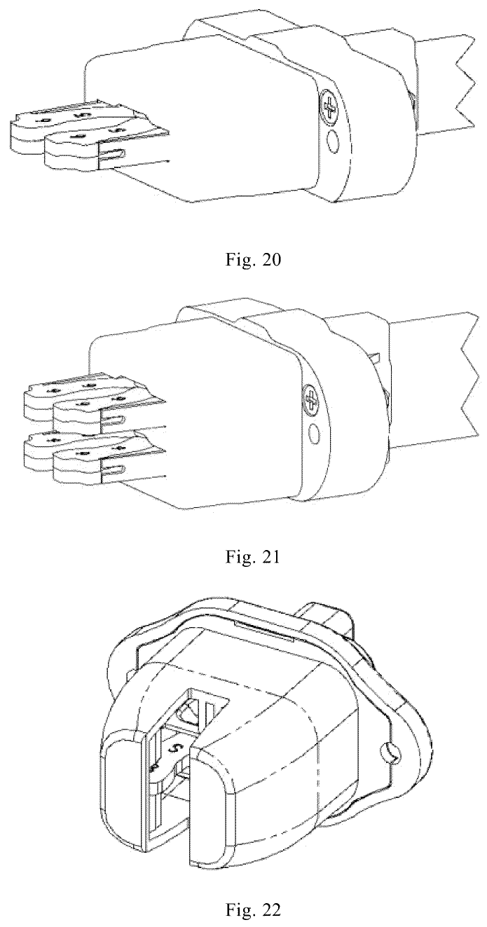

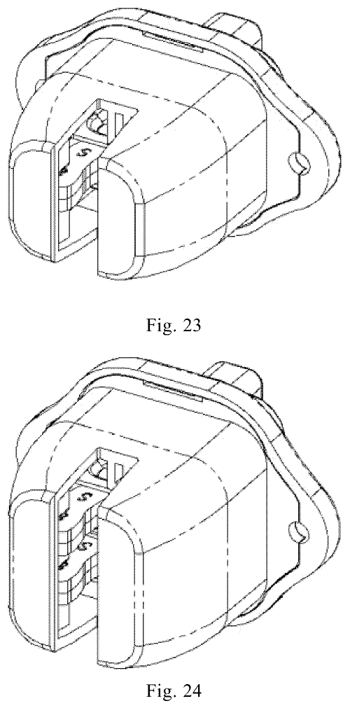

On the basis of achieving the 630 A lapless main circuit connection structure, the same structural principle can likewise be implemented to achieve 1400 A, 250 A, and 125 A lapless main circuit connection structures. As shown in FIG. 21 and FIG. 24, the 400 A dual-socket main circuit connector 3 adopts two sets of 250 A conductive plugs 4. As shown in FIG. 20 and FIG. 23, the 250 A dual-socket main circuit connector 3 adopts one set of 250 A conductive plug 4. As shown in FIG. 19 and FIG. 22, the 125 A dual-socket main circuit connector 3 adopts one set of 125 A conductive plug 4.

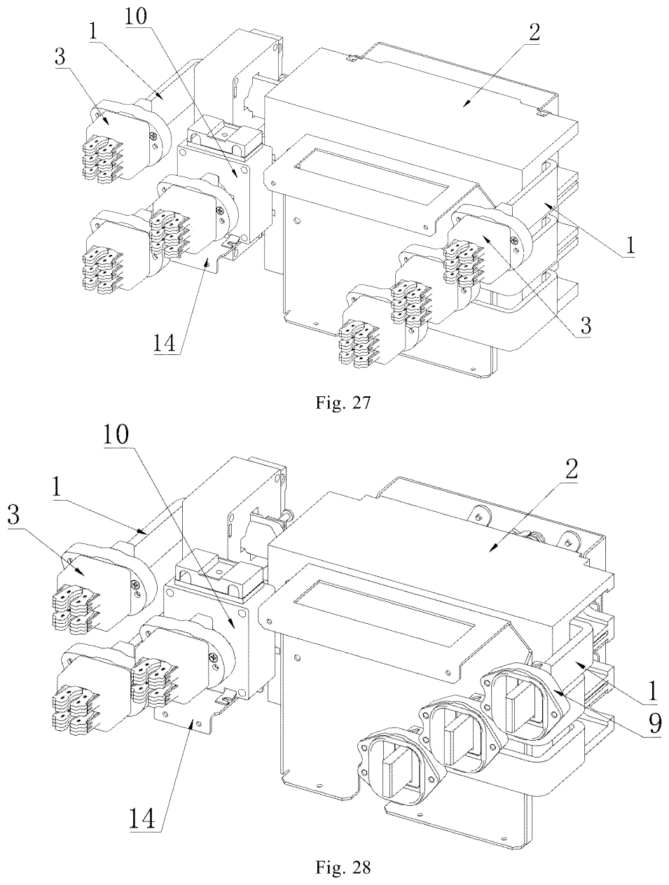

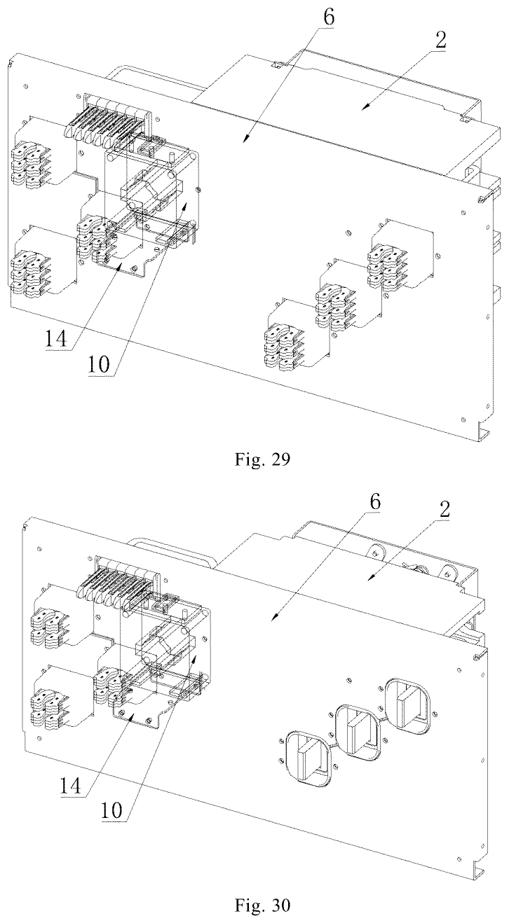

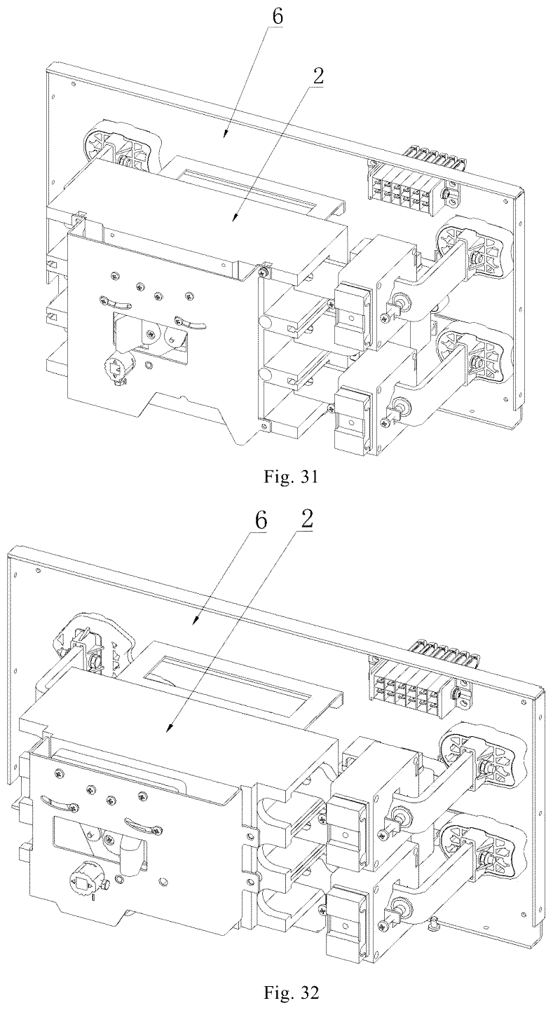

FIG. 25, FIG. 27, FIG. 29, and FIG. 31 show lapless main circuit connection structures adopting the first structural principle on both the incoming side and the outgoing side in the present invention.

FIG. 26, FIG. 28, FIG. 30, and FIG. 32 show lapless main circuit connection structures adopting the second structural principle on the incoming side and adopting the first structural principle on the outgoing side in the present invention.

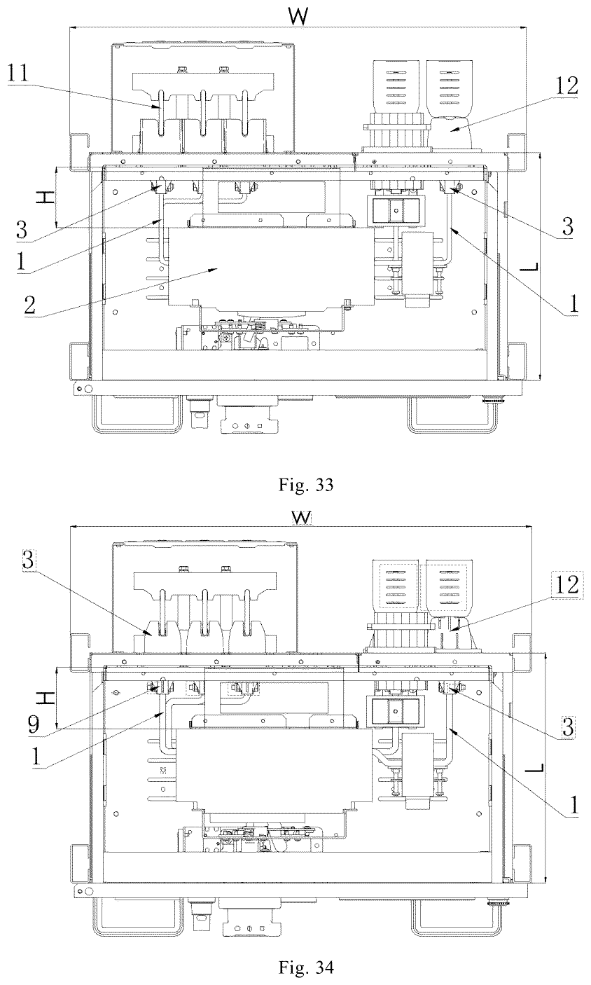

FIG. 33 is a general assembly schematic diagram of a 630 A drawer type unit assembly with a cabinet width W of 600 mm and a unit depth L of 300 mm of a lapless main circuit connection structure adopting the first structural principle. FIG. 36 is a general assembly schematic diagram of a 630 A movable plug-in type unit assembly with a cabinet width W of 600 mm and a unit depth L of 300 mm of a lapless main circuit connection structure adopting the first structural principle according to the present invention. The connection distance H of both two units is 80 mm. In these two unit assemblies, the dual-socket main circuit connectors 3 on the incoming side serve as movable connectors and are connected to the vertical busbars 11 in a plug-in manner, and the dual-socket main circuit connectors 3 on the outgoing side serve as movable connectors and are connected to the outgoing stationary sockets 12 in a plug-in manner.

FIG. 34 is a general assembly schematic diagram of a 630 A drawer type unit assembly with a cabinet width W of 600 mm, a unit depth L of 300 mm and a connection distance H of 80 mm of a lapless main circuit connection structure adopting the second structural principle on the incoming side and the first structural principle on the outgoing side according to the present invention.

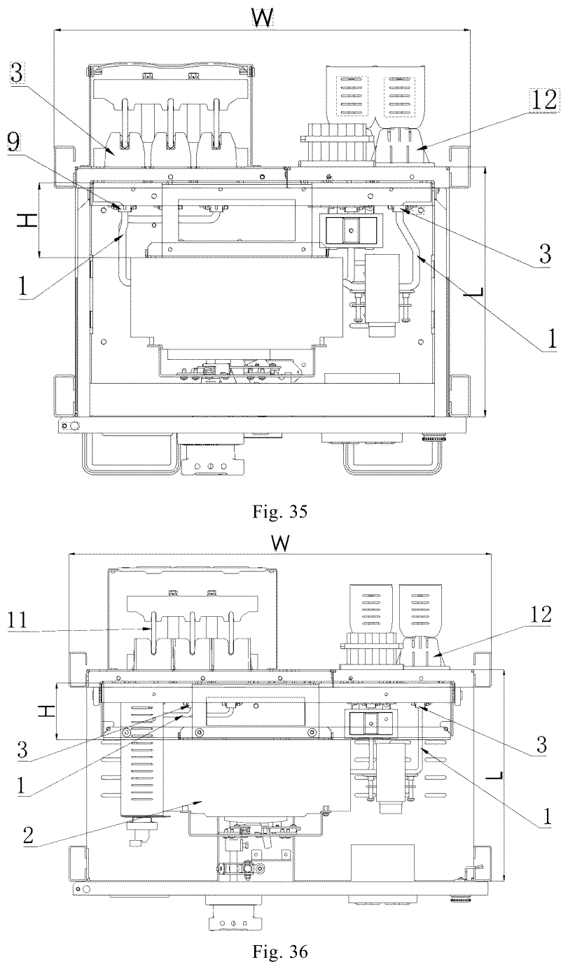

FIG. 35 is a general assembly schematic diagram of a 630 A drawer type unit assembly with a cabinet width W of 500 mm, a unit depth L of 300 mm and a connection distance H of 90 mm of a lapless main circuit connection structure adopting the second structural principle on the incoming side and the first structural principle on the outgoing side according to the present invention. In these two unit assemblies, the dual-socket main circuit connectors 3 on the incoming side serve as stationary connectors and are fixed to the unit chamber rear plate 8 through the plug insulating housings 5, the rear ends of the circuit breaker connector bars 1 serve as movable connectors and are fixed to the unit rear end plate 6 through the movable connector insulating housings 9, and the plug rear sockets 4-2 of the conductive plugs 4 of the dual-socket main circuit connectors 3 are connected to the vertical busbars 11 in a plug-in manner, the rear ends of the circuit breaker connector bars 1 are connected to the plug front sockets 4-1 of the conductive plugs 4 of the dual-socket main circuit connectors 3 in a plug-in manner when the unit is pushed into the connection position, and the dual-socket main circuit connectors 3 on the outgoing side serve movable connectors and are connected to the outgoing stationary sockets 12 in a plug-in manner.

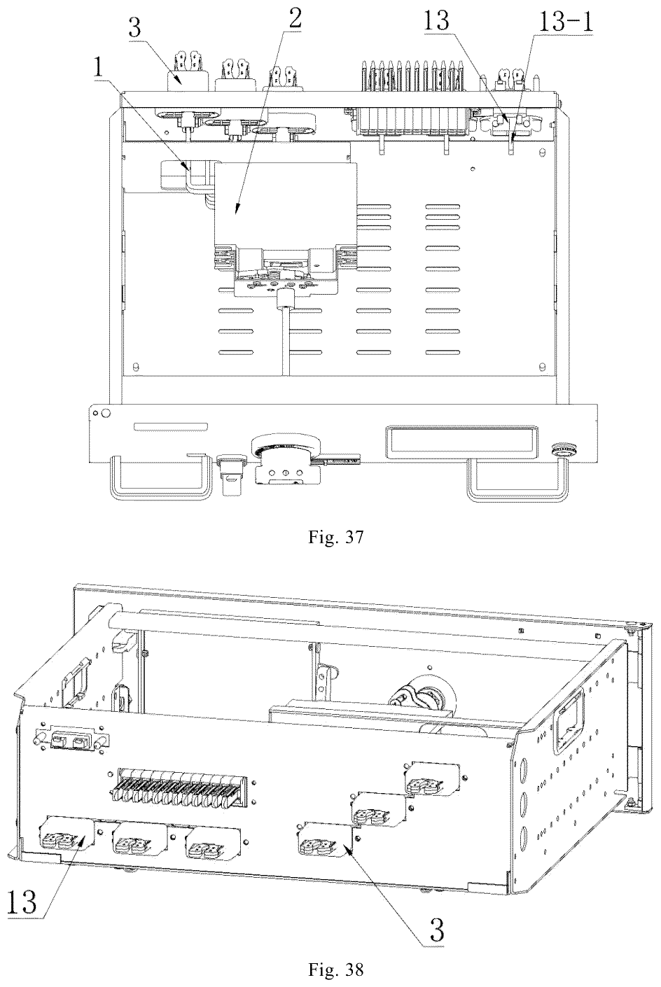

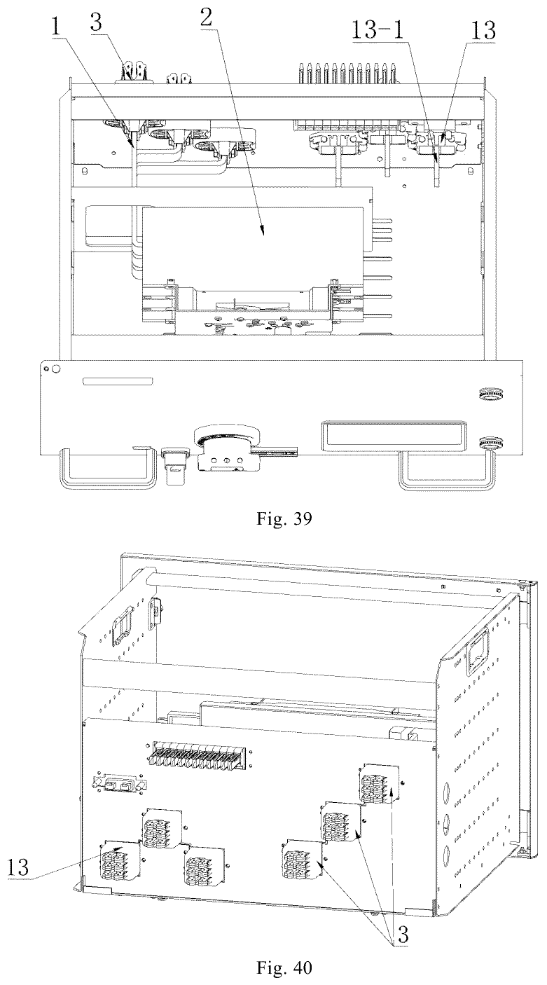

FIG. 37, FIG. 38, FIG. 39, and FIG. 40 are general assembly schematic diagrams of drawer type unit assemblies with a cabinet width W of 600 mm for a control loop of a lapless main circuit connection structure adopting the first structural principle only on the incoming side according to the present invention. In the two unit assemblies, the main circuit connectors on the incoming side are dual-socket main circuit connectors 3, the incoming side of the circuit breakers 2 is connected to the dual-socket main circuit connectors 3 through the circuit breaker connector bars 1 in a lapless manner, the main circuit connectors on the outgoing side are conventional main circuit connectors 13 with terminal bars 13-1, and the outgoing side of the circuit breakers 2 is connected to the main circuit connectors on the outgoing side through conducting wires. The dual-socket main circuit connectors on the incoming side serve as movable connectors and are connected to the vertical busbars 11 in a plug-in manner. The conventional main circuit connectors 13 with the terminal bars 13-1 on the outgoing side serve as movable connectors and are connected to the outgoing stationary socket 12.

Additionally, it should be noted that the bending configuration of the circuit breaker connector bars directly inserted into the plug front sockets of the main circuit connectors may vary, depending on the layout position of the circuit breakers and the arrangement manner of the instrument transformers.

In summary, compared with the prior art, the dual-socket main circuit connectors 3 in the present invention do not have terminal bars 13-1. By omitting the lap joint, the connection distance H and the copper consumption for the copper bars for main circuit connection are reduced.

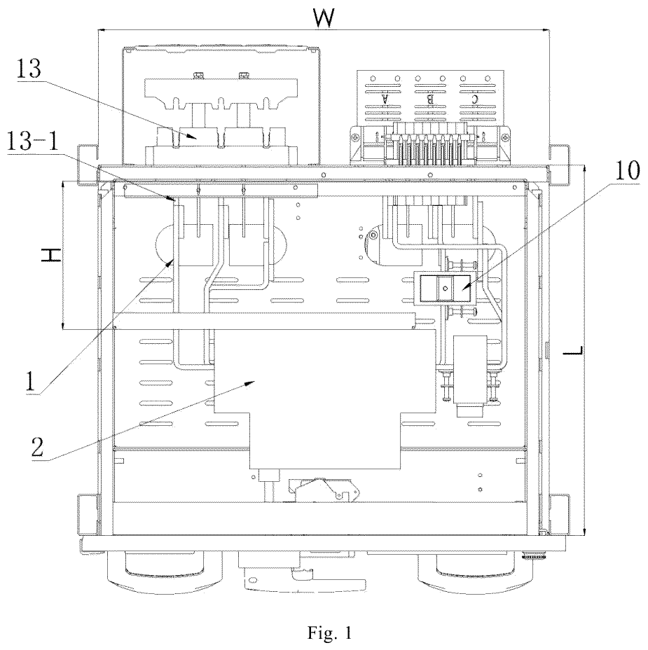

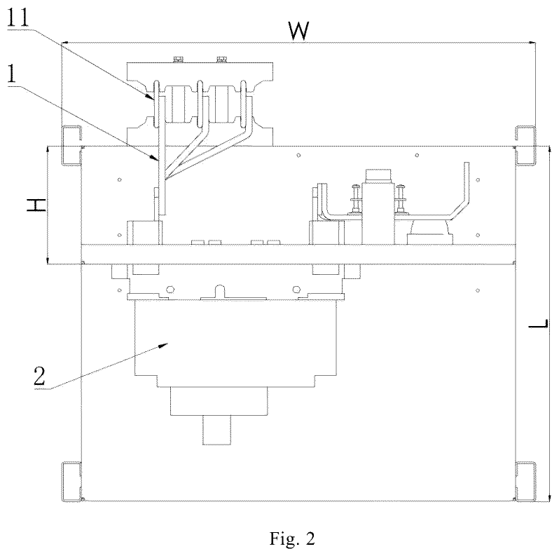

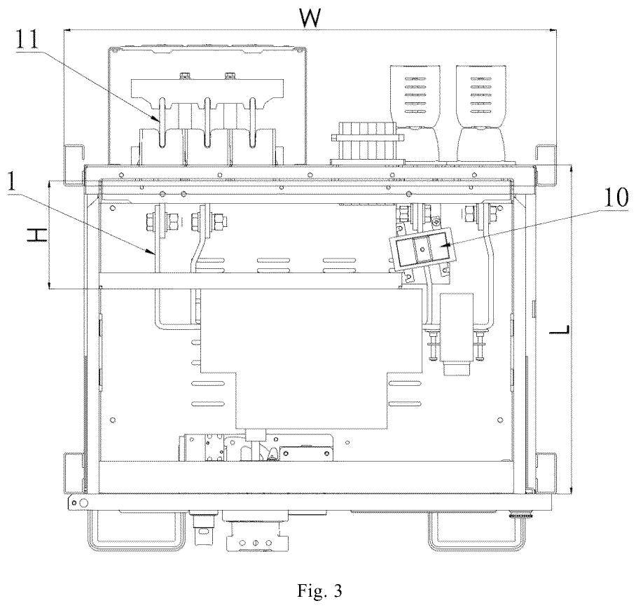

Compared with the units adopting the main circuit connection structures of the prior art shown in FIG. 1, FIG. 2, and FIG. 3, the 630 A unit adopting the lapless main circuit connection structure according to the present invention can further reduce the unit depth L, and achieve a miniaturized 630 A unit with a unit depth L of 300 mm, a cabinet width W of 600 mm, and a cabinet depth of 800 mm. It can also achieve a miniaturized 630 A unit with a cabinet width W of 500 mm, a unit depth L of 350 mm, and a cabinet depth of 800 mm.

The lapless main circuit connection structure according to the present invention is a connection structure with an extremely high degree of standardization. Combined with the phase-to-phase centers CL of the main circuit connectors 3 being arranged corresponding to the phase-to-phase centers CL of the corresponding phases of the circuit breakers 2, it becomes a permanent, finalized design structure after being designed only once.

The installation process of the lapless main circuit connection structure according to the present invention and the circuit breakers 2 is performed on a working platform. Compared with the main circuit connection structure in FIG. 1, it saves 65% of the time, the circuit breaker connector bars 1 save 41% of copper, and the main circuit connectors do not require terminal bars 13-1, saving 27% of copper. The reduction in the unit depth L by 100 to 150 mm achieves equipment miniaturization, saving between 10 kg and 16 kg of steel plate per set of equipment. With the application of this technology in industrial equipment, if each set of equipment comprises 7 to 9 units, the circuit breaker connector bars 1 and the main circuit connectors achieve a 58% reduction in copper consumption.

The lapless main circuit connection structure according to the present invention, compared with the main circuit connection structure in FIG. 1, saves fastening bolts. Compared with the main circuit connection structure in FIG. 2, the circuit breaker connector bars 1 save 15% of copper, the unit depth L can be reduced by 150 mm, the accessory cost is decreased, and for the connection process, the manual installation labor is reduced by 100%, and the unit structural cost per set is reduced by RMB 2000 to 3000. For the cabinet width W of 600 mm and cabinet depth of 800 mm, compared with a cabinet depth of 1000 mm, the occupied area is reduced by 0.12 m²; and for the cabinet width W of 500 mm and cabinet depth of 800 mm, the occupied area is reduced by more.

The number of the low-voltage drawer type and plug-in type switchgears annually applied in this industry is no less than 300,000 sets. Compared with distribution cabinets adopting the unit assemblies of FIG. 1 and FIG. 2 with a cabinet depth of 1000 mm and a cabinet width W of 600 mm, if each set of equipment comprises 7 to 9 units, each set of equipment for different current ratings saves an average of 9.5 kg of copper, omits 42 fastening bolts, uses 15 to 17 kg less steel plate, and requires 3 hours less manufacturing and installation labor.

The structure for connecting the main circuit connectors to the circuit breakers in a lapless manner in the present invention integrates the main and auxiliary circuit assemblies, greatly improves the industrialization and standardization of the design and manufacturing processes of the circuit breaker installation structure, and is applicable to drawer type units and plug-in type units. It is applicable to drawer type switchgears with a cabinet width W of 600 mm, a minimum drawer unit depth of 300 mm, and a cabinet depth of 800 mm, as well as to those with a cabinet width W of 500 mm, a minimum drawer unit depth of 350 mm, and a cabinet depth of 800 mm. It is also applicable to plug-in type switchgears with a cabinet width W of 600 mm, a minimum plug-in type unit assembly depth of 300 mm, and a cabinet depth of 800 mm, as well as to those with a cabinet width W of 500 mm, a minimum plug-in type unit assembly depth of 350 mm, and a cabinet depth of 800 mm. This results in equipment miniaturization, saving copper and other materials. The miniaturized equipment realized by this technology fill a technical gap in the industry's application field, reduce the infrastructure cost, has a smaller equipment external size, reduce the occupied area, and deliver extensive and long-term comprehensive socio-economic benefits.

1. A lapless main circuit connection structure, comprising circuit breaker connector bars and main circuit connectors, the circuit breaker connector bars being used for conductive connection between circuit breakers and the main circuit connectors, the main circuit connectors being connected through conductive plugs in a plug-in manner, characterized in that the main circuit connectors connected to the circuit breakers through the circuit breaker connector bars are dual-socket main circuit connectors, and the circuit breaker connector bars are directly inserted into the dual-socket main circuit connectors and are connected to plug front sockets of the conductive plugs in a plug-in manner.

2. The lapless main circuit connection structure according to claim 1, characterized in that the dual-socket main circuit connectors comprise plug insulating housings and conductive plugs positioned through the plug insulating housings, the conductive plugs are provided with plug front sockets and plug rear sockets, the plug insulating housings are provided with circuit breaker connector bar sockets, and the circuit breaker connector bars are directly inserted into the main circuit connectors through the circuit breaker connector bar sockets and are connected to the plug front sockets of the conductive plugs in a plug-in manner;
the dual-socket main circuit connectors serve as movable connectors and are fixed to a unit rear end plate through the plug insulating housings, and the circuit breaker connector bars and the plug insulating housings are fixed through fasteners.

3. The lapless main circuit connection structure according to claim 1, characterized in that the dual-socket main circuit connectors comprise plug insulating housings and conductive plugs positioned through the plug insulating housings, the conductive plugs are provided with plug front sockets and plug rear sockets, the plug insulating housings are provided with housing front sockets, and the circuit breaker connector bars are directly inserted into the main circuit connectors through the housing front sockets and are connected to the plug front sockets of the conductive plugs in a plug-in manner;
the dual-socket main circuit connectors serve as stationary connectors and are fixed to a unit chamber rear plate through the plug insulating housings, rear ends of the circuit breaker connector bars serve as movable connectors and are fixed to a unit rear end plate through movable connector insulating housings, the movable connector insulating housings are provided with circuit breaker connector bar sockets, the rear ends of the circuit breaker connector bars pass through the circuit breaker connector bar sockets, and the rear ends of the circuit breaker connector bars and the movable connector insulating housings are fixed through fastener.

4. The lapless main circuit connection structure according to claim 2, characterized in that the circuit breaker connector bar sockets have a certain length for guiding the circuit breaker connector bars.

5. The lapless main circuit connection structure according to claim 4, characterized in that the fasteners are detachable fasteners, the detachable fasteners are specifically bolt fasteners, side surfaces of the circuit breaker connector bars and the circuit breaker connector bar sockets are provided with fixing through holes, and the bolt fasteners fix the circuit breaker connector bars by passing through the fixing through holes of the circuit breaker connector bars and the circuit breaker connector bar sockets.

6. The lapless main circuit connection structure according to claim 1, characterized in that main circuit connectors of each phase on an incoming side and an outgoing side connected to the circuit breakers through the circuit breaker connector bars are arranged in layers from top to bottom, phase-to-phase centers CL are arranged corresponding to phase-to-phase centers CL of corresponding phases of the circuit breakers, the main circuit connectors of each phase on the incoming side and the outgoing side connected to the circuit breakers through the circuit breaker connector bars are connected to the corresponding phases of the circuit breakers in a one-to-one correspondence through the circuit breaker connector bars arranged in layers from top to bottom.

7. A unit assembly, specifically a unit assembly of a low-voltage switchgear, comprising a unit and a unit chamber, characterized in that a circuit breaker is installed in the unit, and the circuit breaker is connected to a main circuit through the lapless main circuit connection structure according to claim 1.

8. The unit assembly according to claim 7, characterized in that a B-phase instrument transformer sleeved over a B-phase circuit breaker connector bar on an outgoing side is installed through an instrument transformer bracket installed on a unit rear end plate, and the B-phase instrument transformer is arranged close to a B-phase main circuit connector.

9. The lapless main circuit connection structure according to claim 3, characterized in that the circuit breaker connector bar sockets have a certain length for guiding the circuit breaker connector bars.

10. The lapless main circuit connection structure according to claim 9, characterized in that the fasteners are detachable fasteners, the detachable fasteners are specifically bolt fasteners, side surfaces of the circuit breaker connector bars and the circuit breaker connector bar sockets are provided with fixing through holes, and the bolt fasteners fix the circuit breaker connector bars by passing through the fixing through holes of the circuit breaker connector bars and the circuit breaker connector bar sockets.

11. A unit assembly, specifically a unit assembly of a low-voltage switchgear, comprising a unit and a unit chamber, characterized in that a circuit breaker is installed in the unit, and the circuit breaker is connected to a main circuit through the lapless main circuit connection structure according to claim 2.

12. The unit assembly according to claim 11, characterized in that a B-phase instrument transformer sleeved over a B-phase circuit breaker connector bar on an outgoing side is installed through an instrument transformer bracket installed on a unit rear end plate, and the B-phase instrument transformer is arranged close to a B-phase main circuit connector.

13. A unit assembly, specifically a unit assembly of a low-voltage switchgear, comprising a unit and a unit chamber, characterized in that a circuit breaker is installed in the unit, and the circuit breaker is connected to a main circuit through the lapless main circuit connection structure according to claim 3.

14. The unit assembly according to claim 13, characterized in that a B-phase instrument transformer sleeved over a B-phase circuit breaker connector bar on an outgoing side is installed through an instrument transformer bracket installed on a unit rear end plate, and the B-phase instrument transformer is arranged close to a B-phase main circuit connector.

15. A unit assembly, specifically a unit assembly of a low-voltage switchgear, comprising a unit and a unit chamber, characterized in that a circuit breaker is installed in the unit, and the circuit breaker is connected to a main circuit through the lapless main circuit connection structure according to claim 6.

16. The unit assembly according to claim 15, characterized in that a B-phase instrument transformer sleeved over a B-phase circuit breaker connector bar on an outgoing side is installed through an instrument transformer bracket installed on a unit rear end plate, and the B-phase instrument transformer is arranged close to a B-phase main circuit connector.
